(19) United States
(12) Patent Application Publication
(10) Pub. No.: US 2010/0079899 A1
(43) Pub. Date: Apr. 1, 2010

(54) STORAGE APPARATUS AND METHOD OF ADJUSTING THE SAME

(75) Inventor: Hideki Hironaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/511,736

(22) Filed: Jul. 29, 2009

(30) Foreign Application Priority Data
Sep. 26, 2008 (JP) 2008-247175

(51) Int. Cl. G11B 21/02

(52) U.S. Cl. 360/75; G9B/21.003

(57) ABSTRACT

A storage apparatus includes a controller circuit controlling the operation of a head actuator for moving a head relative to a storage medium. The storage apparatus further includes an acceleration sensor detecting acceleration. A notch filter outputs the result of detection of the acceleration sensor to the controller circuit. A frequency setting circuit is configured to set the notch frequency of the notch filter in accordance with a resonance frequency of the acceleration sensor.

### CROSS-REFERENCE TO RELATED APPLICATION

This application is based upon and claims the benefit of priority from the prior Japanese Patent Application No. 2008-247175 filed on Sep. 26, 2008, the entire contents of which are incorporated herein by reference.

### FIELD

The embodiments discussed herein are related to a storage apparatus such as a hard disk drive, for example.

### BACKGROUND

A rack-mount type server computer is well known, for example. A plural number of server computers are mounted on the rack. Rack units such as a disk array apparatus or apparatuses, a power source apparatus or apparatuses, and the like, are also mounted on the rack, for example. The server computer is subjected to slight and quick vibrations under the influence of the operation of a cooling fan and the other driven components.

### Publication 1: JP Patent Application Laid-open No. 2001-326548

At least a disk drive is installed in the server computers and the disk array apparatus or apparatuses, for example. When the disk drive is subjected to vibrations, servo control of a head, namely positioning control for a head, is disturbed. The narrower the intervals get between the adjacent recording tracks, the greater the influence of the vibrations gets.

### SUMMARY

According to a first aspect of the present invention, there is provided a storage apparatus including a controller circuit controlling the operation of a head actuator for moving a head relative to a storage medium, the storage apparatus comprising: an acceleration sensor detecting acceleration; a notch filter outputting the result of detection of the acceleration sensor to the controller circuit; and a frequency setting circuit configured to set the notch frequency of the notch filter in accordance with a resonance frequency of the acceleration sensor.

According to a second aspect of the present invention, there is provided a method of adjusting a storage apparatus, comprising: applying vibrations to the storage apparatus based on the movement of a component incorporated in the storage apparatus; receiving the output of an acceleration sensor mounted in the storage apparatus; obtaining a resonance frequency of the acceleration sensor in accordance with the output of the acceleration sensor; and adjusting the notch frequency of a notch filter based on the resonance frequency of the acceleration sensor.

The object and advantages of the embodiment will be realized and attained by means of the elements and combinations particularly pointed out in the appended claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a plan view schematically depicting a hard disk drive, HDD, as a specific example of a storage apparatus;

FIG. 2 is a plan view of a printed circuit board for schematically depicting first and second acceleration sensors;

FIG. 3 is a block diagram schematically depicting a control system of a head actuator, namely a tracking servo circuit, according to a specific example;

FIG. 4 is a graph depicting the relationship between the output characteristics of the acceleration sensors and the damping characteristics of notch filters;

FIG. 5 is a flowchart schematically depicting a method of setting the notch frequency;

FIG. 6 is a graph depicting signals output from the acceleration sensors in response to vibrations;

FIG. 7 is a graph depicting the frequency characteristics of the acceleration sensors including the resonance frequency of the acceleration sensors; and

FIG. 8 is a block diagram schematically depicting a control system of a head actuator, namely a tracking servo circuit, according to another specific example.

### DESCRIPTION OF EMBODIMENT

Embodiments of the present invention will be explained below with reference to the accompanying drawings.

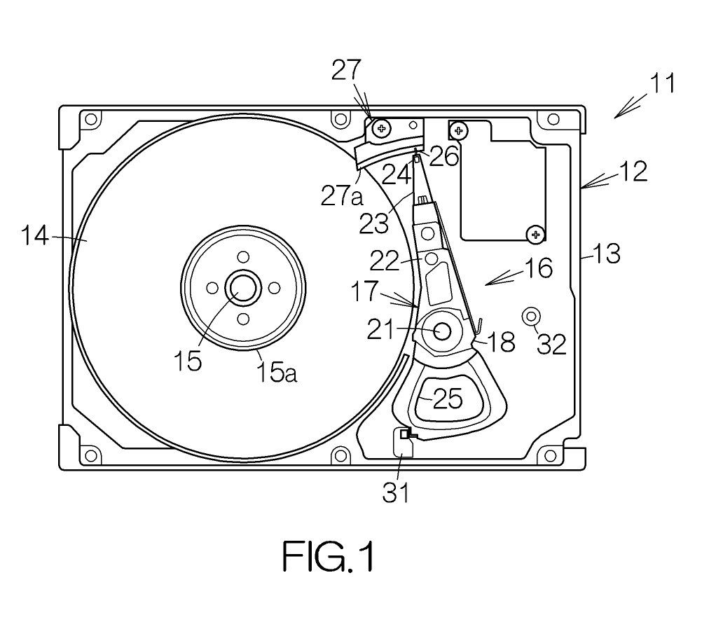

FIG. 1 schematically illustrates the structure of a hard disk drive, HDD, 11 as an example of a storage medium drive or storage apparatus. The hard disk drive 11 includes an enclosure 12. The enclosure 12 includes a box-shaped enclosure base 13 and an enclosure cover, not illustrated. The box-shaped enclosure base 13 defines an inner space in the shape of a flat parallelepiped, for example. The enclosure base 13 may be made of a metallic material such as aluminum (Al), for example. Casting process may be employed to form the enclosure base 13. The enclosure cover is coupled to the enclosure base 13. The enclosure cover closes the opening of the enclosure base 13. Pressing process may be employed to form the enclosure cover out of a plate material, for example.

At least one magnetic recording disk 14 as a magnetic recording medium is incorporated within the inner space of the enclosure base 13. The magnetic recording disk or disks 14 is mounted on the driving or spindle shaft of a spindle motor 15. A clamp 15a is attached to the tip end of the spindle shaft. The clamp 15a is utilized to fix the magnetic recording disk or disks 14 on the spindle shaft. The spindle motor 15 drives the magnetic recording disk or disks 14 at a higher revolution speed such as 5,400 rpm, 7,200 rpm, 10,000 rpm, 15,000 rpm, or the like. The individual magnetic recording disk 14 may be a so-called perpendicular magnetic recording medium.

A head actuator 16 is incorporated in the hard disk drive 11. The head actuator 16 includes a carriage 17 located in the inner space of the box-shaped enclosure base 13. The carriage 17 includes a carriage block 18. The carriage block 18 is coupled to a vertical pivotal shaft 21 for relative rotation. The vertical pivotal shaft 21 stands upright from the bottom plate of the box-shaped enclosure base 13. Carriage arms 22 are defined in the carriage block 18. The carriage arms 22 extend in a horizontal direction from the vertical pivotal shaft 21. The carriage block 18 may be made of aluminum (Al), for example. Extrusion process may be employed to form the carriage block 18, for example.

A head suspension 23 is attached to the front or tip end of the individual carriage arm 22. The head suspension 23 extends forward from the carriage arm 22. A flexure is attached to the head suspension 23. A flying head slider 24 is supported on the flexure. The elastic deformation of the flexure allows the flying head slider 24 to change its attitude relative to the head suspension 23. A head element, namely an electromagnetic transducer, not illustrated, is mounted on the flying head slider 24.

The electromagnetic transducer includes a write element and a read element. A so-called single pole head is employed as the write element, for example. The single pole head generates a magnetic field with the assistance of a thin film coil pattern. A main magnetic pole serves to direct the magnetic flux to the magnetic recording disk 14 in the perpendicular direction perpendicular to the surface of the magnetic recording disk 14. The magnetic flux is utilized to write binary data into the magnetic recording disk 14. A giant magnetoresistive (GMR) element or a tunnel-junction magnetoresistive (TMR) element is employed as the read element. Variation in the electric resistance is induced in a spin valve film or a tunnel-junction film in response to the inversion of polarization in the magnetic field applied from the magnetic recording disk 14, for example. The read element discriminates binary data on the magnetic recording disk 14 based on the induced variation in the electric resistance.

When the magnetic recording disk 14 rotates, the flying head slider 24 is allowed to receive airflow generated along the rotating magnetic recording disk 14. The airflow serves to generate a positive pressure or lift as well as a negative pressure on the flying head slider 24. The lift of the flying head slider 24 is balanced with the urging force of the head suspension 23 and the negative pressure so that the flying head slider 24 keeps flying above the surface of the magnetic recording disk 14 at a higher stability during the rotation of the magnetic recording disk 14.

A voice coil 25 is coupled to the carriage block 18. A yoke, not illustrated, is opposed to the voice coil 25 at a predetermined distance. The voice coil 25 and the yoke in combination establish a voice coil motor, VCM. The voice coil motor is incorporated in the head actuator 16. The voice coil 25 generates a magnetic flux in response to the supply of electric current. A driving force is generated in the voice coil 25 based on the magnetic flux. The carriage block 18 is driven for rotation around the vertical pivotal shaft 21 in response to the application of the driving force. The rotation of the carriage block 18 allows the carriage arms 22 and the head suspensions 23 to swing. When the individual carriage arm 22 swings around the vertical pivotal shaft 21 during the flight of the flying head slider 24, the flying head slider 24 is allowed to move in the radial direction of the magnetic recording disk 14. The electromagnetic transducer on the flying head slider 24 is thus allowed to cross concentric recording tracks defined between the innermost and outermost recording tracks. The movement of the flying head slider 24 allows the electromagnetic transducer on the flying head slider 24 to be positioned right above a target recording track on the magnetic recording disk 14. In this manner, the electromagnetic transducer is allowed to move along the surface of the magnetic recording disk 14.

A load tab 26 is defined in the front or tip end of the individual head suspension 23. The load tab 26 extends further forward from the tip end of the head suspension 23. The swinging movement of the carriage arm 22 allows the load tab 26 to move along the radial direction of the magnetic recording disk 14. A ramp member 27 is located on the movement path of the load tab 26 in a space outside the outer periphery of the magnetic recording disk or disks 14. The ramp member 27 is fixed to the enclosure base 13. The load tab 26 is received on the ramp member 27 when the magnetic recording disk or disks 14 stands still. The ramp member 27 may be made of a hard plastic material, for example. Molding process may be employed to form the ramp member 27.

The ramp member 27 includes ramps 27a each extending along the movement path of the corresponding load tab 26. The ramp 27a gets farther from an imaginary plane including the corresponding surface of the magnetic recording disk or disks 14 as the position gets farther from the rotation axis of the magnetic recording disk 14. When the carriage arm 22 is driven to swing around the vertical pivotal shaft 21 in the normal direction, the tip end of the head suspension 23 gets farther from the rotation axis of the magnetic recording disk 14. The load tab 26 slides upward along the corresponding ramp 27a. The flying head slider 24 is in this manner distanced from the surface of the magnetic recording disk 14. The flying head slider 24 is unloaded into the space outside the outer contour of the magnetic recording disk 14. When the carriage arm 22 is driven to swing around the vertical pivotal shaft 21 in the reverse direction, the tip end of the head suspension 23 gets closer to the rotation axis of the magnetic recording disk 14. The load tab 26 slides downward along the corresponding ramp 27a. The rotating magnetic recording disk 14 serves to generate a lift on the flying head slider 24. The ramp member 27 and the load tabs 26 in combination establish a so-called load/unload mechanism.

The head actuator 16 includes a first stop 31 and a second stop 32. The first and second stops 31, 32 are fixed to the bottom plate of the enclosure base 13, for example. A predetermined central angle is established around the longitudinal axis of the vertical pivotal shaft 21 between the first and second stops 31, 32 within a horizontal plane perpendicular to the longitudinal axis of the vertical pivotal shaft 21. When the carriage arms 22 are driven to swing farthest around the vertical pivotal shaft 21 in the normal direction, the voice coil 25 collides against the first stop 31. The swinging movement of the carriage arms 22 is restricted. The individual load tab 26 is prevented from falling off the corresponding ramp 27a. The carriage arms 22 are driven to swing farthest around the vertical pivotal shaft 21 in the reverse direction, the voice coil 25 collides against the second stop 32. The swinging movement of the carriage arms 22 is restricted. The tip end of the uppermost head suspension 23 is prevented from contacting with the clamp 15a. In this manner, the first and second stops 31, 32 serve to define the limits of the swinging range of the voice coil 25, namely the movement range of the electromagnetic transducers.

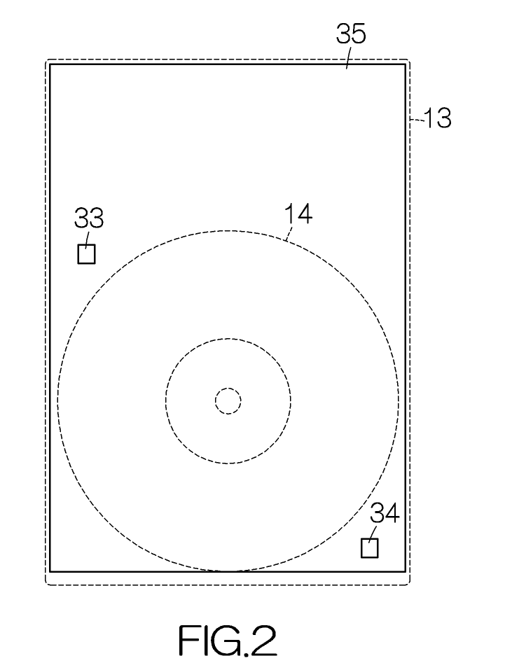

As depicted in FIG. 2, a first acceleration sensor 33 and a second acceleration sensor 34 are incorporated in the hard disk drive 11. The first and second acceleration sensors 33, 34 are configured to detect a predetermined acceleration in response to deformation in a piezoelectric element, for example. The first and second acceleration sensors 33, 34 are mounted on a printed circuit board 35. When the hard disk drive 11 is subjected to impact of an external force, for example, the first and second acceleration sensors 33, 34 detect acceleration. A predetermined central angle is established around the longitudinal axis of the spindle shaft between the first and second acceleration sensors 33, 34 within a horizontal plane perpendicular to the longitudinal axis of the spindle shaft. The printed circuit board 35 is fixed to the bottom plate of the enclosure base 13 from the outside of the enclosure 12.

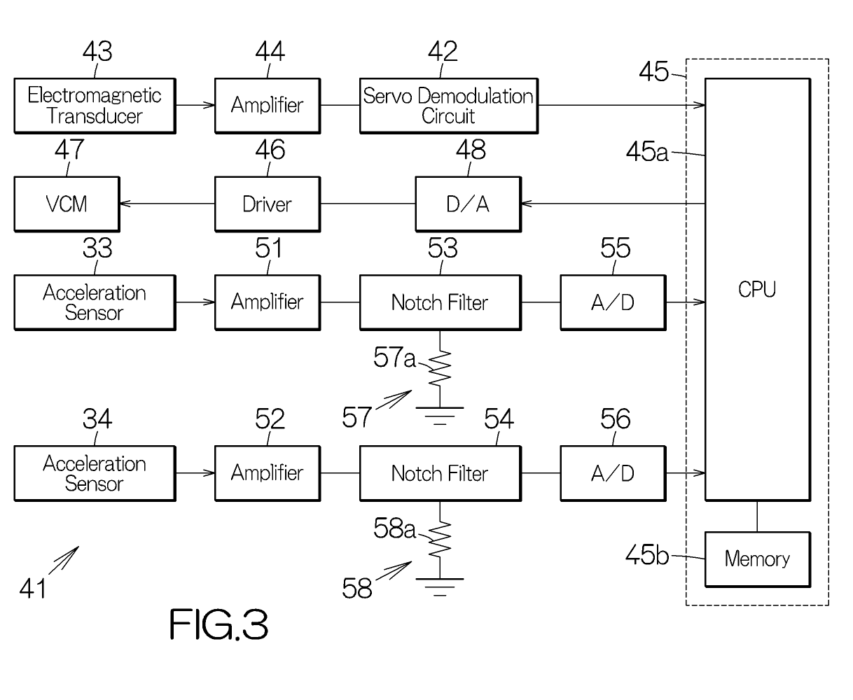

FIG. 3 schematically depicts the structure of a control system of the head actuator 16, namely a tracking servo circuit 41. The tracking servo circuit 41 includes a servo demodulation circuit 42. The servo demodulation circuit 42 is connected to the aforementioned electromagnetic transducer 43, specifically the read element. An amplifying circuit (amplifier) 44 is connected between the electromagnetic transducer 43 and the servo demodulation circuit 42. The electromagnetic transducer 43 converts magnetic bit data on the magnetic recording disk 14 into an electric signal, namely variation in voltage. The amplifying circuit 44 amplifies the electric signal. The servo demodulation circuit 42 determines deviation of the electromagnetic transducer 43 from the centerline of the recording track in accordance with the variation in voltage. The determined deviation is supplied to a controller circuit 45. The controller circuit 45 includes a CPU (central processing unit) 45a, for example. A memory 45b is connected to the CPU 45a. The CPU 45a executes various kinds of processing based on software programs (including firmware) and data held in the memory 45b.

A driver circuit 46 is connected to the controller circuit 45. The driver circuit 46 is connected to a voice coil motor 47. A digital-analog (D/A) converter 48 is connected between the driver circuit 46 and the controller circuit 45. The controller circuit 45 outputs an instruction signal in the form of a digital signal to the voice coil motor 47. The instruction signal is converted into an analog signal through the digital-analog converter 48. A driving current is supplied to the voice coil 25 of the voice coil motor 47 from the driver circuit 46 in response to the supply of the analog signal. The voice coil 25 generates the driving force in response to the supply of the driving current. The voice coil motor 47 exhibits a driving force for counteracting the deviation of the electromagnetic transducer 43. In this manner, tracking servo is executed. The electromagnetic transducer 43 is allowed to follow the target recording track.

The first and second acceleration sensors 33, 34 are connected to the controller circuit 45. Amplifying circuits (amplifiers) 51, 52 are connected to the first and second acceleration sensors 33, 34, respectively. The output of the first and second acceleration sensors 33, 34 is amplified through the amplifying circuits 51, 52, respectively. Notch filters 53, 54 are connected to the amplifying circuits 51, 52, respectively. The notch filters 53, 54 have a predetermined notch frequency. The notch filter 53 (or 54) serves to damp the output of the first acceleration sensor 33 (or the second acceleration sensor 34) at the predetermined notch frequency. Analog-digital (A/D) converters 55, 56 are connected to the notch filters 53, 54, respectively. In this manner, the output of the first and second acceleration sensors 33, 34 is supplied to the controller circuit 45 as a digital signal. The notch filters 53, 54 may be Gm-C filters, for example.

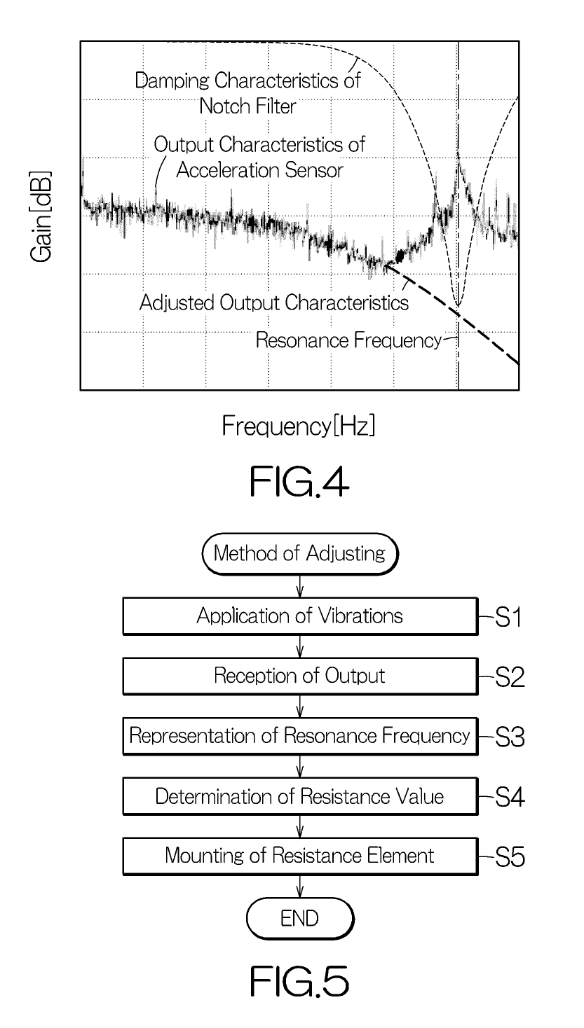

Frequency setting circuits 57, 58 are connected to the notch filters 53, 54, respectively. The frequency setting circuits 57, 58 include resistance elements 57a, 58a. Resistors are employed as the resistance elements 57a, 58a, for example. The resistors are mounted on the printed circuit board 35, for example. The resistance element 57a (or 58a) has an electrical resistance of a predetermined value set in accordance with the resonance frequency of the first acceleration sensor 33 (or the second acceleration sensor 34). The resistance element 57a (or 58a) serves to correspond the notch frequency of the notch filter 53 (or 54) to the resonance frequency of the first acceleration sensor 33 (or 34), as depicted in FIG. 4, for example. As a result, the output of the first acceleration sensor 33 (or the second acceleration sensor 34) damps to the utmost at the resonance frequency of the first acceleration sensor 33 (or the second acceleration sensor 34) through the notch filter 53 (or 54). The gain of the output of the first acceleration sensor 33 (or the second acceleration sensor 34) recovers in a high frequency range above the resonance frequency of the first acceleration sensor 33 (or the second acceleration sensor 34). As is apparent from FIG. 4, after adjusted through the notch filters 53, 54, the output of the acceleration sensors 33, 34 exhibit specific output characteristics smoothly declining as the frequency gets higher. The influence of resonance is eliminated.

Now, assume that the hard disk drive 11 is subjected to slight and quick vibrations, namely vibrations of a high frequency, for example. The first and second acceleration sensors 33, 34 detect acceleration. The outputs of the first and second acceleration sensors 33, 34 are supplied to the notch filters 53, 54, respectively, after amplified through the amplifying circuits 51, 52. The notch filters 53, 54 serve to damp the output of the first and second acceleration sensors 33, 34 in a range of the resonance frequency of the first and second acceleration sensors 33, 34, respectively. As a result, the analog-digital converters 55, 56 receive electric signals precisely reflecting the vibrations of a high frequency. The controller circuit 45 generates a driving signal to counteract the vibrations of a high frequency. The driving signal is superimposed on the output of the servo demodulation circuit 42. In this manner, the influence of the vibrations in eliminated in the tracking servo. Even under the circumstances where the hard disk drive 11 continuously suffers from vibrations, for example, the electromagnetic transducer 43 is allowed to reliably keep following the recording track.

Next, a brief description will be made on a method of setting the aforementioned notch frequency in the process of making the hard disk drive 11. Prior to the setting, the magnetic recording disk 14, the flying head slider 24, the head actuator 16, and the like, are incorporated in the enclosure 12. The printed circuit board 35 is attached to the bottom plate of the enclosure base 13 from the outside of the enclosure 12. Probes are connected to the output terminals of the amplifying circuits 51, 52, respectively. The tip ends of the probes may be connected to wiring patterns formed between the output terminals of the amplifying circuits 51, 52 and the corresponding notch filters 53, 54, respectively. The outputs of the first and second acceleration sensors 33, 34 are obtained before being input into the notch filters 53, 54. A connecting terminal may be formed in the printed circuit board 35 for establishment of the connection.

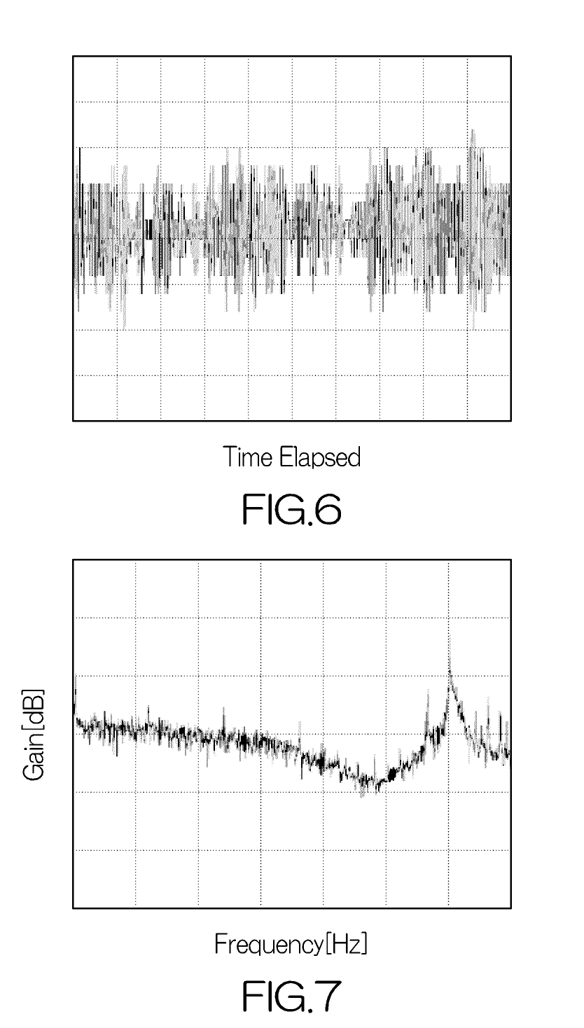

As depicted in FIG. 5, the enclosure 12 of the hard disk drive 11 is subjected to vibrations based on an external force at step S1. A solid is forced to collide against the enclosure 12 so as to apply an impact, for example. As a result, as depicted in FIG. 6, for example, the outputs of the first and second acceleration sensors 33, 34, having been amplified, are obtained through the probes. A frequency characteristic representing device receives the output at step S2.

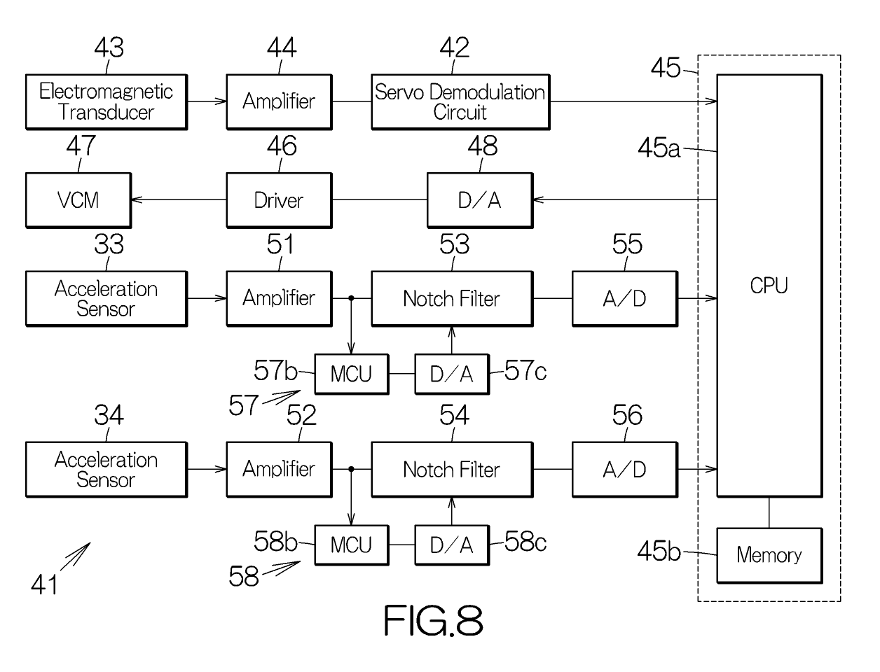

The frequency characteristic representing device performs fast Fourier transform, FFT, on the output. As a result, the frequency characteristics of the first and second acceleration sensors 33, 34 are represented as depicted in FIG. 7. The average of the representations resulting from the FFT may be utilized to represent the frequency characteristics. The resonance frequencies of the first and second acceleration sensors 33, 34 are determined based on the represented frequency characteristics at step S3. The resonance frequency is determined based on the nominal notch frequency of the notch filter 53 or 54 specified in the product specification of the notch filters 53 or 54, for example. The maximum value is picked up in a frequency range covering equal frequency ranges above and below the nominal notch frequency. The picked-up maximum value corresponds to the actual resonance frequency of the first or acceleration sensor 33, 34 obtained through actual measurement. The resonance frequencies of the first and second acceleration sensors 33, 34 are determined in this manner.

An operator determines at step S4 the electrical resistance values of resistance elements to be connected to the notch filters 53, 54, respectively, based on the determined resonance frequencies. The electrical resistance values correspond to predetermined values capable of establishing the determined resonance frequencies of the first and second acceleration sensors 33, 34. Here, resistance elements having electrical resistances of the predetermined values are prepared, for example. The resistance elements 57a, 58a are mounted on the printed circuit board 35 at step S5. The resistance elements 57a, 58a are connected to the notch filters 53, 54, respectively. In this manner, the resonance frequencies of the first and second acceleration sensors 33, 34 are adjusted to correspond to the notch frequencies of the notch filters 53, 54, respectively, through actual measurement.

The head actuator 16 in the enclosure 12 may be utilized to apply vibrations in the aforementioned method of setting the notch frequency. Here, collision of the voice coil 25 with the second stop 32 is utilized, for example. The carriage arms 22 are driven to rapidly swing around the vertical pivotal shaft 21 in the reverse direction. The driver circuit 46 supplies a driving current to the voice coil 25 in response to an instruction signal supplied from the controller circuit 45.

As depicted in FIG. 8, for example, the frequency setting circuits 57, 58 may include microcontroller units (MCU) 57b, 58b in place of the aforementioned resistance elements 57a, 58a, respectively. The microcontroller units 57b, 58b may function as a specific example of the processing section. The microcontroller units 57b, 58b output driving signals, namely driving voltages, of digital value, respectively. The digital values are set in accordance with the resonance frequencies of the notch filters 53, 54. The driving voltage is converted into an analog driving voltage through digital-analog converters 57c, 58c. The analog driving voltage is applied to the notch filters 53, 54. In this manner, the notch frequencies of the notch filters 53, 54 can be adjusted to correspond to the resonance frequencies of the first and second acceleration sensors 33, 34, respectively, in accordance with the voltages applied to the notch filters 53, 54.

As is apparent from FIG. 8, the outputs of the amplifying circuits 51, 52 may be supplied to the microcontroller units 57b, 58b of the frequency setting circuits 57, 58, respectively. The frequency setting circuits 57, 58 allow the hard disk drive 11 itself to determine the notch frequency of the notch filters 53, 54. In this case, the voice coil 25 is driven to collide against the second stop 32 so as to subject the hard disk drive 11 to vibrations in the same manner as described above. The movement of a component, namely the voice coil 25, is utilized to generate vibrations in the hard disk drive 11. The first and second acceleration sensors 33, 34 detect acceleration. The outputs of the first and second acceleration sensors 33, 34 are amplified through the amplifying circuits 51, 52, respectively. The amplified outputs are then supplied to the microcontroller units 57b, 58b, respectively. The microcontroller units 57b, 58b perform fast Fourier transform, FFT, on the outputs of the amplifying circuits 51, 52, respectively. As a result, the resonance frequencies of the acceleration sensors 33, 34 are determined in the same manner as described above. The microcontroller units 57b, 58b set the notch frequencies of the notch filters 53, 54 in accordance with the resonance frequencies of the first and second acceleration sensors 32, 33. In this manner, the notch frequencies of the notch filters 53, 54 can accurately be adjusted to correspond to the resonance frequencies of the acceleration sensors 33, 34, respectively. It should be noted that the CPU 45a may take over the operation of the microcontroller units 57b, 58b.

The techniques according to the embodiments can be applied not only to a hard disk drive utilizing a magnetic disk medium of the aforementioned type but also to an optical disk drive utilizing an optical disk medium without changing the structures.

All examples and conditional language recited herein are intended for pedagogical purposes to aid the reader in understanding the invention and the concept contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus including a controller circuit controlling operation of a head actuator for moving a head relative to a storage medium, the storage apparatus comprising:
an acceleration sensor detecting acceleration;
a notch filter outputting a result of detection of the acceleration sensor to the controller circuit; and
a frequency setting circuit configured to set a notch frequency of the notch filter in accordance with a resonance frequency of the acceleration sensor.

2. The storage apparatus according to claim 1, wherein the frequency setting circuit includes a resistance element connected to the notch filter, the resistance element having an electrical resistance of a predetermined value set in accordance with the resonance frequency.

3. The storage apparatus according to claim 1, wherein the frequency setting circuit includes:
a processing section outputting a driving voltage of a digital value set in accordance with the resonance frequency; and
a digital-analog converting section performing a digital-analog conversion on the driving voltage output from the processing section for applying the driving voltage to the notch filter.

4. The storage apparatus according to claim 1, wherein the controller circuit generates a driving signal based on the result of the detection output from the notch filter so as to control a position of the head relative to the storage medium.

5. A method of adjusting a storage apparatus, comprising:
applying vibrations to the storage apparatus based on a movement of a component incorporated in the storage apparatus;
receiving output of an acceleration sensor mounted in the storage apparatus;
obtaining a resonance frequency of the acceleration sensor in accordance with the output of the acceleration sensor; and
adjusting a notch frequency of a notch filter based on the resonance frequency of the acceleration sensor.

6. The method according to claim 5, further comprising applying voltage of a predetermined value to the notch filter in accordance with the resonance frequency of the acceleration sensor for adjusting the notch frequency.

7. The method according to claim 5, further comprising connecting a resistance element to the notch filter for adjusting the notch frequency, the resistance element having an electrical resistance of a predetermined value set in accordance with the resonance frequency of the acceleration sensor.

8. The method according to claim 6, further comprising causing collision of a head actuator against a stop based on operation of a controller circuit for applying the vibrations, the stop defining a limit of a movement range of the head actuator, the controller circuit configured to control operation of the head actuator for moving a head along a surface of a storage medium in the storage apparatus.
